(19) United States
(12) Patent Application Publication
(10) Pub. No.: US 2022/0405193 A1
(43) Pub. Date: Dec. 22, 2022

(54) Runtime Error Prediction System

(71) Applicant: Bank of America Corporation, Charlotte, NC (US)

(72) Inventors: Ashok, Gurugram (IN); Durga Prasad Kutthumolu, Hyderabad (IN); Suryanarayana Adivi, Miyapur (IN); Mukesh Batra, Kothaguda (IN)

(21) Appl. No.: 17/354,917

(22) Filed: Jun. 22, 2021

(51) Int. Cl. G06F 11/36; G06F 8/33; G06N 20/00; G06F 8/61

(52) U.S. Cl. CPC G06F 11/3624; G06F 8/33; G06N 20/00; G06F 8/61

(57) ABSTRACT

During a software development lifecycle of a software application, application code is modified and multiple versions are built and packaged to be installed on different computing systems, such as on a software development computing system, a software testing computing systems, and/or production or end-user computing systems. A runtime error optimization engine analyzes, using a first artificial intelligence model, a build package to predict whether it may encounter runtime errors causing an installation to fail. When an error is identified, a runtime error orchestration engine may utilize a second artificial intelligence model to identify a solution, where the runtime error orchestration engine rebuilds the build package based on an identified solution and initiates installation via a deployment pipeline.

### BACKGROUND

During a software development lifecycle, software applications are built and packaged for delivery. In some cases, build packages may encounter runtime errors causing an installation to fail. Often, these runtime errors are never identified, saved or scanned at any stage in development so, even in a perfect system, runtime errors may be encountered many years after product launch.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with accurately evaluating instruments for authenticity and validity.

Aspects of the disclosure relate to intelligent prediction of runtime errors that may be encountered during an installation of a software application. One or more aspects of the disclosure relate to a system agnostic intelligent artificial intelligence (AI) computing system to intelligently predict production-based runtime errors at a pre-build stage, determine a solution to the runtime error, and automatically repackage the software application build.

During a software development lifecycle of a software application, the application code is modified and multiple versions are built and packaged to be installed on different computing systems, such as on a software development computing system, a software testing computing systems, and/or production or end-user computing systems. Build packages may encounter runtime errors causing an installation to fail, where the causes of the failures may not be identified or resolved. As such, a need has been recognized for an artificial intelligent computing system capable of predicting runtime errors of software application build packages, resolving the predicted runtime errors, and automatically repackaging the build to significantly reduce a probability that a runtime error will occur during installation.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative block diagram of an artificial intelligence-based computing system to automatically predict and resolve runtime build errors in accordance with one or more aspects described herein;

FIG. 2 shows an illustrative method runtime error prediction computing system in accordance with one or more aspects described herein;

FIG. 3 shows an illustrative method to predict runtime errors in accordance with one or more aspects described herein;

FIG. 4 shows an illustrative runtime error prediction operating environment in which various aspects of the disclosure may be implemented in accordance with one or more aspects described herein; and

FIG. 5 shows an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The above-described examples and arrangements are merely some example arrangements in which the systems described herein may be used. Various other arrangements employing aspects described herein may be used without departing from the invention.

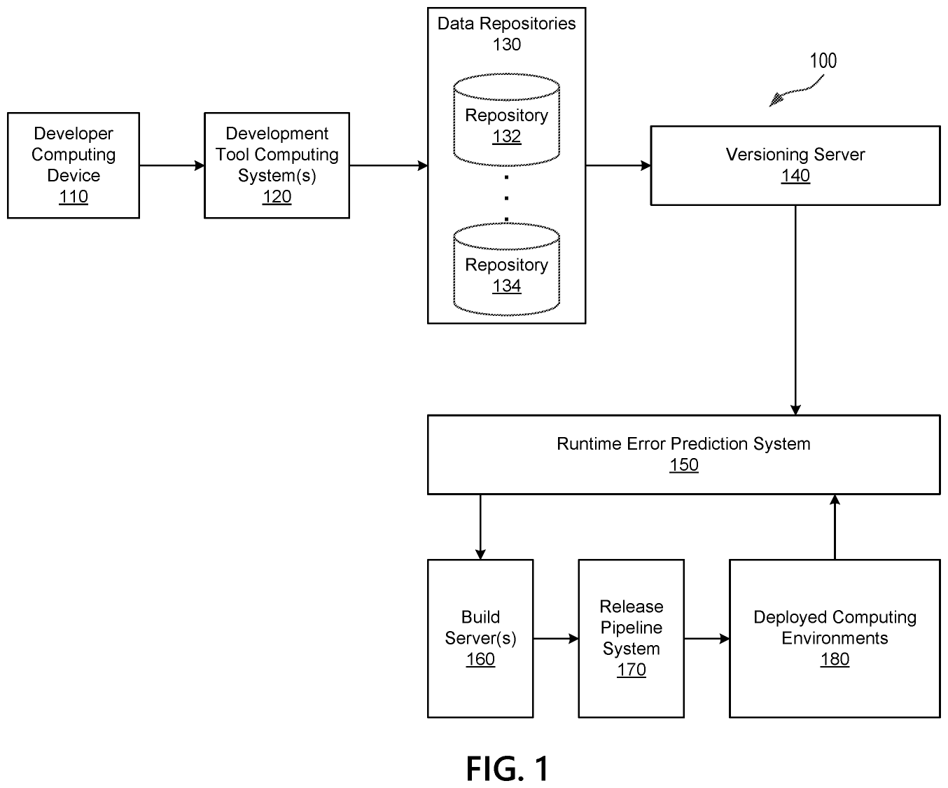

FIG. 1 shows an illustrative block diagram of an artificial intelligence-based computing system 100 in accordance with one or more aspects described herein. The artificial intelligence-based computing system 100 includes one or more developer computing systems 110 communicatively coupled to at least one development tool computing system 120 to facilitate development and coding of one or more software applications. In some cases, the developers may use the developer computing system to deploy code through continuous integration and/or continuous deployment methodologies to provide the code to production. The development tools installed on the at least one development tools computing systems may include open source and/or other tools that may be configured to facilitate code creation and/or initial testing. The code may be stored in one or more code repositories, such as the data repositories 130. In some cases, the data repositories 130 may include different code repositories, such as a production code repository 132 and a test code version repository 134 and the like, that may be configured to store code generated received from at least one development tool computing systems 120. A versioning service 140 may be used for storage of versions of code deployments of code from one or more of the code data repositories 130.

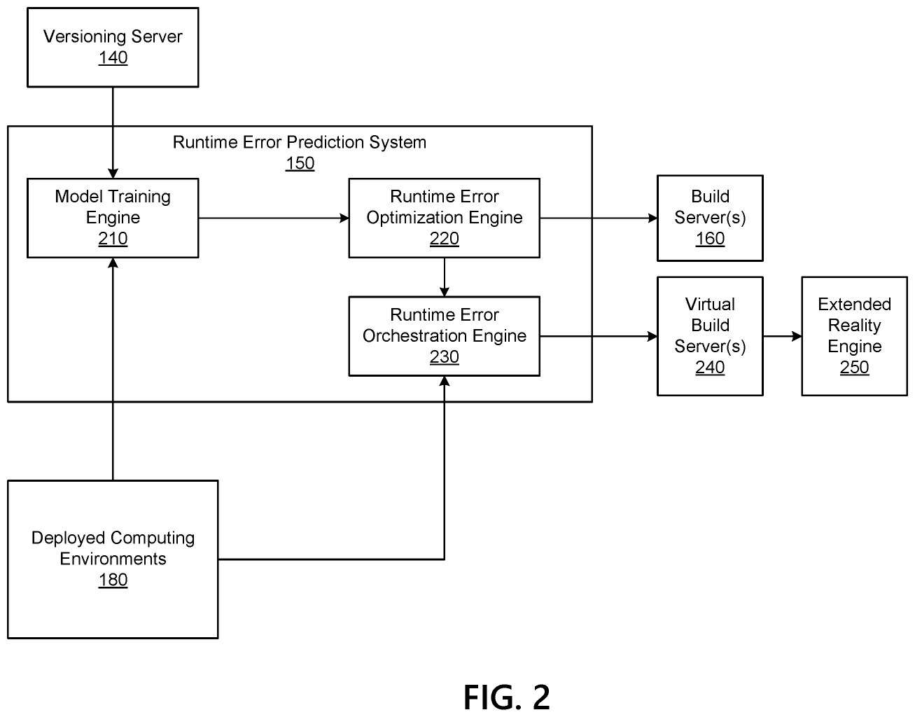

The runtime error prediction system 150, as discussed in greater detail with respect to FIG. 2, may include an AI computing system that utilizes one or more trained models to predict whether a build version, managed by the versioning server 140 may likely be subject to runtime errors when deployed in a computing environment, such as the deployed computing environments 180. In some cases, the build server 160 and the release pipeline system 170 may include one or more software applications to facilitate delivery of software applications that may automatically set up delivery pipelines and integrations, such as by managing configurations. In some cases, the build server 160 and/or release pipeline system 170 may detect a computing language of the software code (e.g., C, Python, and the like), automatically build a version of the software application, perform tests and/or measure code quality. In some cases, the build server 160 and/or release pipeline system 170 may be capable of scanning the code for potential security vulnerabilities and/or flaws or licensing issues. The release pipeline system 170 may then automatically deploy the software application to one or more deployed computing environments 180, such as a development computing system (e.g., a development computing device), a testing or quality assurance computing system and/or a production computing environment (e.g., a production server).

FIG. 2 shows an illustrative method runtime error prediction computing system 150 in accordance with one or more aspects described herein. In some cases, the runtime error prediction computing system 150 may include a model training engine 210, a runtime error optimization engine 220, and a runtime error orchestration engine 230. The model training engine may be communicatively coupled, via a network, to the versioning sever 140 and the one or more computing environments 180 to receive information about a build and/or a status of a successful or unsuccessful deployment of the software application.

The model training engine 210 may collect historical production version information and/or test framework code from one or more different software development tool computing systems and/or software test computing systems, such as from the versioning server 140. Additionally, the model training engine 210 may collect historical production version run time error information and/or fixed solution information, such as from the deployed computing environments (e.g., installation log information, system log information, and the like). The model training engine may train the model based on the gathered historical source code information and/or the runtime error information and fixed solution information, such as by utilizing an unconventional usage deep learning recurrent neural network algorithm.

The runtime error optimization engine 220 may utilize the AI learning model (e.g., a supervised model, an unsupervised model, and the like), such as a classic neural network model, a convolutional neural network model, a recurrent neural network model, a self-organizing map model, a Boltzmann machine model, an autoencoder model, and the like. In some cases, the runtime error optimization engine 220 may monitor for new inputs, such as a new production version release indication, a new test version release indication, a revised version release indication that may be received from the versioning server 140 during a code push. The runtime error optimization engine 220, upon receiving an indication of a new version push, may automatically analyze, using the trained model, to identify and/or predict possible runtime errors. In some cases, the runtime error optimization engine 220 may associate prediction information, such as an indication of successful runtime operation, a prediction of runtime errors, and indication of an indeterminate runtime result (e.g., when a prediction that the build will encounter runtime errors or will install correctly is not determinative), with a version, such as in a data entry in one or more of the code repositories 130 or other data storage associated with the versioning server 140 or the runtime error prediction system 150. Version information may include software component information, build configuration information, prediction information and the like. In some days, prediction information may be stored in metadata that may be associated with versioning information and stored in a data repository associated with the runtime error prediction system 150.

In some cases, the runtime error prediction system 150 may predict a run time error during a pre-build stage. For example, the runtime error prediction system 150 may receive an input identifying a new production build, a new development build, or a new production build from the versioning server. The runtime error optimization engine 220 may identify a runtime error or may predict a runtime error based on processing of the input using the trained AI deep learning model trained using information of historical successful builds and historical runtime errors encountered in one or more production environments. If the runtime error optimization engine 220 predicts no errors—no predicted run time errors to be encountered on the production servers with the build, the runtime error optimization engine 220 may clear a flag (e.g., a runtime error flag=0). Based on this flag, the runtime error optimization engine 220 indicates to the build server 160 that a particular build is good to deploy to production, and the build server 160 may be triggered by the flag to build the version release package via a release pipeline computing system 170 to be deployed to one or more applicable deployed computing environments, such as a production computing environment, a testing computing environment and/or a development computing environment. Status information from the deployment that may indicate a successful deployment and/or whether one or more errors were encountered during deployment may be saved and/or communicated (e.g., pushed, pulled) to the model training engine 210 and/or the runtime error orchestration engine 230.

In some cases, the runtime error optimization engine 220 may analyze new inputs such as new production version information, test framework code components that may be received from the versioning server 140. The runtime error optimization engine 220 may process the trained model to detect and/or predict production-based run time errors and may set a flag identifying description of a predicted runtime error. For example, the runtime error optimization engine 220 process new production version information using the trained model to identify or predict a likelihood that if the version was built and deployed, a high likelihood exists that this deployed version will crash when installed on production servers with run time errors. In such cases (e.g., when a probability that a version will crash meets or exceeds a threshold condition), the runtime error optimization engine 220 may route the version information to a runtime error orchestration engine 230 to be analyzed and processed to automatically resolve the identified errors and may route the version for repackaging.

The runtime error orchestration engine 230 may include one or more artificial intelligence models (e.g., an autoregressive language model) such as a generative pre-trained transformer (GPT-3) model. Such models may allow the runtime error orchestration engine 230 to analyze queries and/or source code and produce human-like text or database queries to automatically reconfigure the build code for the versioning server. For example, the runtime error orchestration engine 230 may generate SQL code to configure a build process for a version of the software application. The runtime error orchestration engine 230 may process the artificial intelligence model to the code by resolving identified runtime errors based on its historical learning of the trained model that is based on historical production run time errors and/or solutions to the historical runtime errors. When the runtime error orchestration engine 230 receives information regarding a predicted runtime error input (e.g., text information) from the runtime error optimization engine 220, the artificial intelligence model (e.g., the GPT-3 model) may process the predicted runtime error input text and generate new code with an identified solution and push the resolved version build code to the to the data repositories 130 for repackaging and deployment. In some cases, when the runtime error orchestration engine 230 analysis by the AI model may result in an unresolved runtime error condition. In such cases, the runtime error orchestration engine 230 may send a notification to another system to virtually deploy the version predicted to have an error for further analysis. For example, the runtime error orchestration engine may trigger a deployment of the subject version of the software application to a virtual environment via a virtual build server 240, so that the virtual deployment may be analyzed via an extended reality engine 250. The extended reality engine 250 may utilize extended reality (XR) environment(s) that combine real computing environments, virtual computing environments, and human-machine interactions via remote computing technology and/or wearable computing components. For example, the extended reality engine may allow humans (e.g., developers, engineers, business users, subject matter experts, support team members, and the like) to interact with the virtual build environment to analyze and collaborate to identify a solution for use in future deployments. Once a solution is found, the results may be automatically sent to the runtime error prediction system 150 for use in training one or more AI models.

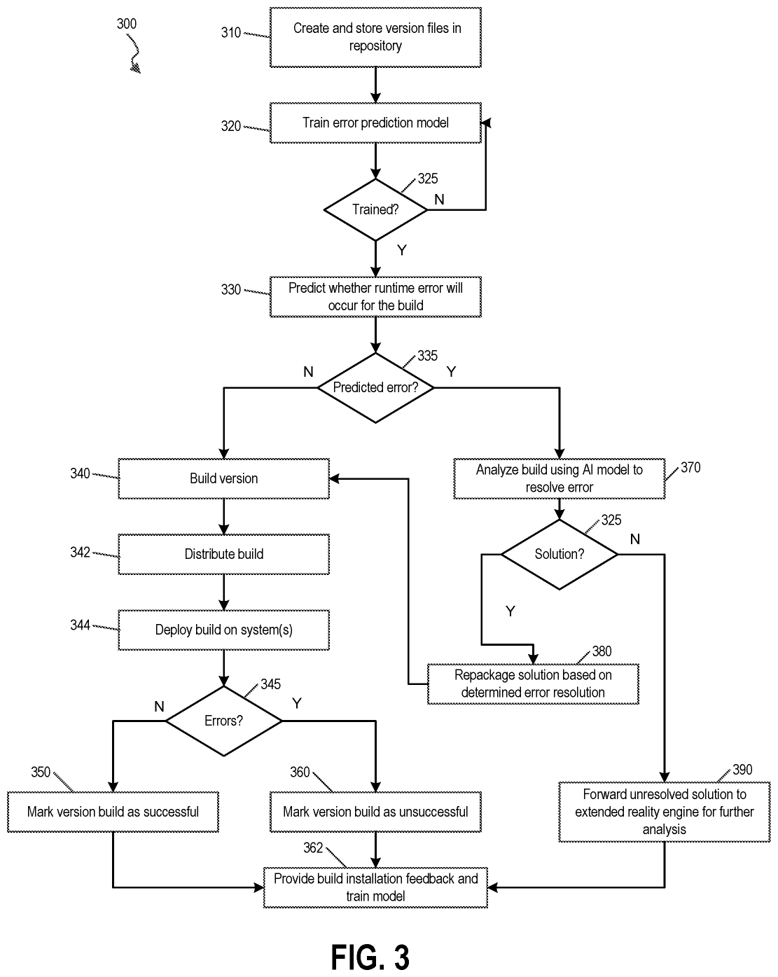

FIG. 3 shows an illustrative method 300 to predict runtime errors in accordance with one or more aspects described herein. At 310, software application code may be created by one or more developers using the developer computing device 110 and at least one development tool computing systems 120, where version files may be created and stored in the data repositories 130. At 320, an error prediction model may be trained, in some cases the model training may be performed in parallel to the creation and storage of the version files of the software application. The model training may be continuous and leverage historical results of runtime error predictions by the runtime error optimization engine 220 and/or runtime error logs from deployment computing system 180. At 325, the status of the model training is monitored, where if incomplete, the training process continues at 320. If, at 325, the model training is completed by the model training engine 210, the runtime error optimization engine 210 predicts, using an AI model, whether a runtime error is likely to occur when deployed on a deployment computing system 180 at 330. If, at 335, a runtime error is not predicted, the runtime error prediction system 150 may cause delivery of the version information to the build server 160 and trigger a release of the build. For example, at 340, the version of the software application may be built by the build server 160, sent via a release pipeline computing system 170 for distribution at 342 and may then be deployed on one or more of the distribution computing systems 180 at 344. At 345, the runtime error prediction system 150 may analyze log files from the one or more distribution computing systems 180 to determine whether a runtime error occurred 345. If not, the runtime error prediction system 150 may mark a version as “good” (e.g., using metadata or a flag). If, a runtime error had been encountered, the version may be marked with an error. The runtime error prediction system may update a data repository storing information about success or failure of version installations and may provide installation feedback information for use in training one or more AI models at 362.

If, at 335, the runtime error optimization engine 220 predicts an error may likely occur for the new version, the runtime error orchestration engine 230 may analyze the version build code using an AI model (e.g., the GPT-3 model) to identify and automatically resolve the error at 370. If a resolution was found, the runtime error orchestration engine 230 may automatically generate build code and store the build code in the repositories 130 and trigger a new build of the version at 340. If, at 325, the runtime error orchestration engine's analysis by the AI model was unsuccessful in determining a solution, the unresolved solution may be forwarded to the extended reality engine 250 for further analysis at 390. Results of the analysis via the extended reality engine 250 may be provided back to the runtime error prediction system 150 for use in training the AI models at 362.

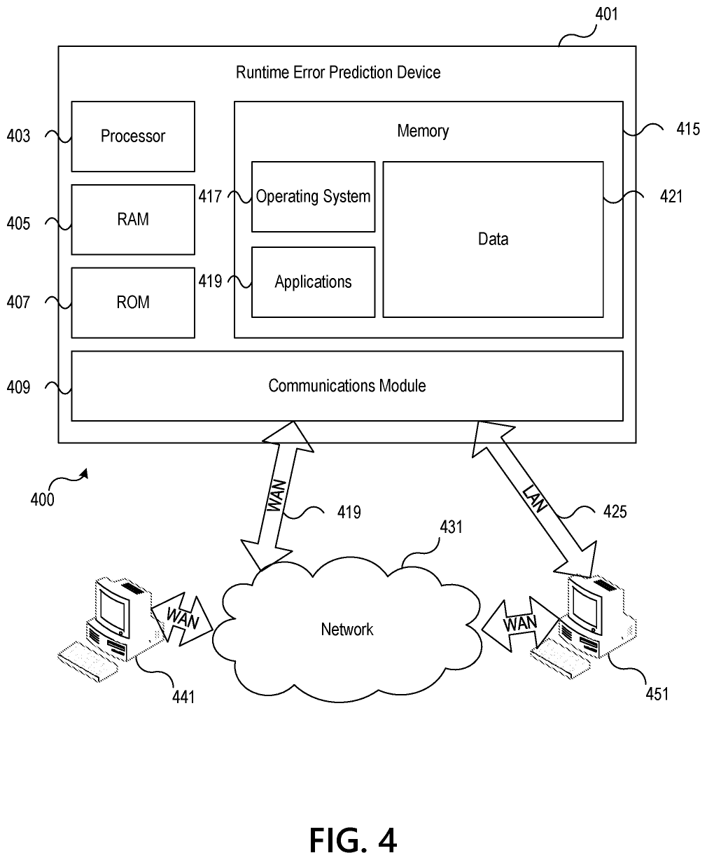

FIG. 4 shows an illustrative operating environment in which various aspects of the present disclosure may be implemented in accordance with one or more illustrative configurations. Referring to FIG. 4, a computing system environment 400 may be used according to one or more illustrative embodiments. The computing system environment 400 is only one example of a suitable computing environment and is not intended to suggest any limitation as to the scope of use or functionality contained in the disclosure. The computing system environment 400 should not be interpreted as having any dependency or requirement relating to any one or combination of components shown in the illustrative computing system environment 400.

The computing system environment 400 may include an illustrative runtime error prediction device 401 having a processor 403 for controlling overall operation of the runtime error prediction device 401 and its associated components, including a Random Access Memory (RAM) 405, a Read-Only Memory (ROM) 407, a communications module 409, and a memory 415. The runtime error prediction device 401 may include a variety of computer readable media. Computer readable media may be any available media that may be accessed by the runtime error prediction device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by the runtime error prediction device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed by the processor 403 of the runtime error prediction device 401. Such a processor may execute computer-executable instructions stored on a computer-readable medium.

Software may be stored within the memory 415 and/or other digital storage to provide instructions to the processor 403 for enabling the runtime error prediction device 401 to perform various functions as discussed herein. For example, the memory 415 may store software used by the runtime error prediction device 401, such as an operating system 417, one or more application programs 419, and/or an associated database 421. In addition, some or all of the computer executable instructions for the runtime error prediction device 401 may be embodied in hardware or firmware. Although not shown, the RAM 405 may include one or more applications representing the application data stored in the RAM 405 while the runtime error prediction device 401 is on and corresponding software applications (e.g., software tasks) are running on the runtime error prediction device 401.

The communications module 409 may include a microphone, a keypad, a touch screen, and/or a stylus through which a user of the runtime error prediction device 401 may provide input, and may include one or more of a speaker for providing audio output and a video display device for providing textual, audiovisual and/or graphical output. The computing system environment 400 may also include optical scanners (not shown).

The runtime error prediction device 401 may operate in a networked environment supporting connections to one or more remote computing devices, such as the computing devices 441 and 451. The computing devices 441 and 451 may be personal computing devices or servers that include any or all of the elements described above relative to the runtime error prediction device 401.

The network connections depicted in FIG. 4 may include a Local Area Network (LAN) 425 and/or a Wide Area Network (WAN) 429, as well as other networks. When used in a LAN networking environment, the runtime error prediction device 401 may be connected to the LAN 425 through a network interface or adapter in the communications module 409. When used in a WAN networking environment, the runtime error prediction device 401 may include a modem in the communications module 409 or other means for establishing communications over the WAN 429, such as a network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

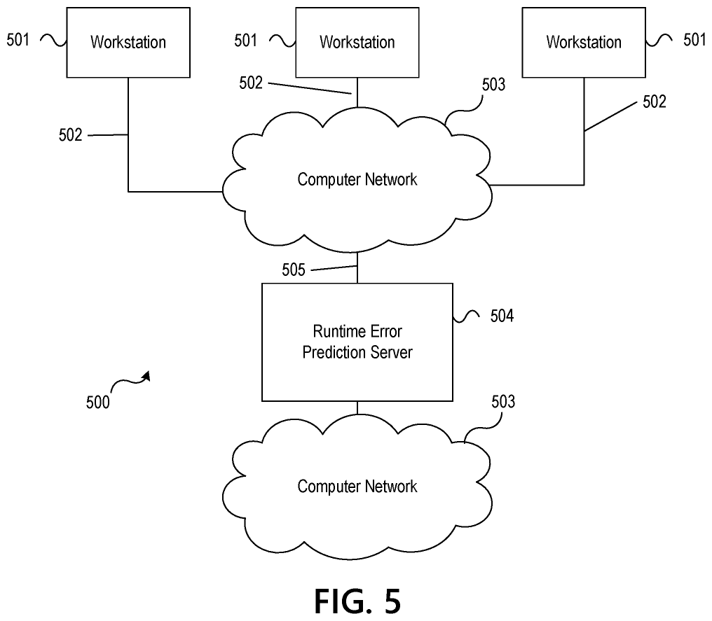

FIG. 5 shows an illustrative block diagram of workstations and servers that may be used to implement the processes and functions of certain aspects of the present disclosure in accordance with one or more example embodiments. For example, an illustrative system 500 may be used for implementing illustrative embodiments according to the present disclosure. As illustrated, the system 500 may include one or more workstation computers 501. The workstation 501 may be, for example, a desktop computer, a smartphone, a wireless device, a tablet computer, a laptop computer, and the like, configured to perform various processes described herein. The workstations 501 may be local or remote, and may be connected by one of the communications links 502 to a computer network 503 that is linked via the communications link 505 to the runtime error prediction server 504. In the system 500, the runtime error prediction server 504 may be a server, processor, computer, or data processing device, or combination of the same, configured to perform the functions and/or processes described herein. The runtime error prediction server 504 may be used to receive check images and associated data and/or validation scores, retrieve user profile, evaluate the check image compared to the user profile, identify matching or non-matching elements, generate user interfaces, and the like.

The computer network 503 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. The communications links 502 and 505 may be communications links suitable for communicating between the workstations 501 and the runtime error prediction server 504, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A method comprising:
predicting, by a runtime error optimization engine and based on a trained artificial intelligence (AI) prediction model, whether a first build of a software application will encounter a runtime error when deployed on a computing device;
analyzing, by a runtime error orchestration engine based on a predicted runtime error and by a second AI model, the build to determine a resolution to a predicted error; and
repackaging, automatically by the runtime error orchestration engine, components of the software application into a second build of the software application.

2. The method of claim 1, comprising:
training the AI prediction model based on an analysis of a plurality of historical build packages and a plurality of historical data logs received from one or more deployed computing environments.

3. The method of claim 2, wherein each historical build package of the plurality of historical build packages corresponds to a historical data log of an installation of the historical build package on deployed computing environment having a first configuration.

4. The method of claim 1, further comprising:
forwarding, by the runtime error orchestration engine for an unresolved predicted runtime error, components of a build package for analysis via an extended reality engine.

5. The method of claim 4, comprising installing the build package in a virtual computing environment.

6. The method of claim 1, further comprising:
building, automatically based on an indication of no predicted errors, a build package of a version of the software application;
deploying the build package on one or more deployed computing environments; and
training the AI prediction model based on information of the build package and installation logs retrieved from the deployed computing environments.

7. A system comprising:
a deployment computing environment; and
a runtime error prediction computing device comprising:
a processor; and
memory storing instructions that, when executed by the processor, cause the runtime error prediction computing device to:
predict, by a runtime error optimization engine and based on a trained artificial intelligence (AI) prediction model, whether a first build of a software application will encounter a runtime error when deployed on a computing device;
analyze, by a runtime error orchestration engine based on a predicted runtime error and by a second AI model, the build to determine a resolution to a predicted error; and
repackage, automatically by the runtime error orchestration engine, components of the software application into a second build of the software application.

8. The system of claim 7, wherein the instructions further cause the runtime error prediction computing device to:
train the AI prediction model based on an analysis of a plurality of historical build packages and a plurality of historical data logs received from one or more deployed computing environments.

9. The system of claim 8, wherein each historical build package of the plurality of historical build packages corresponds to a historical data log of an installation of the historical build package on deployed computing environment having a first configuration.

10. The system of claim 7, wherein the instructions further cause the runtime error prediction computing device to:
forward, via a network and by the runtime error orchestration engine for an unresolved predicted runtime error, components of a build package for analysis via an extended reality engine.

11. The system of claim 10, wherein the instructions further cause the runtime error prediction computing device to install the build package in a virtual computing environment.

12. The system of claim 7, wherein the instructions further cause the runtime error prediction computing device to:
build, automatically based on an indication of no predicted errors, a build package of a version of the software application;
deploy the build package on one or more deployed computing environments; and
train the AI prediction model based on information of the build package and installation logs retrieved from the deployed computing environments.

13. One or more non-transitory memory devices storing instructions that, when executed by a processor, cause a computing device to:
predict, by a runtime error optimization engine and based on a trained artificial intelligence (AI) prediction model, whether a first build of a software application will encounter a runtime error when deployed on a computing device;
analyze, by a runtime error orchestration engine based on a predicted runtime error and by a second AI model, the build to determine a resolution to a predicted error; and
repackage, automatically by the runtime error orchestration engine, components of the software application into a second build of the software application.

14. The one or more non-transitory memory devices of claim 13, wherein the instructions further cause the runtime error prediction computing device to:
train the AI prediction model based on an analysis of a plurality of historical build packages and a plurality of historical data logs received from one or more deployed computing environments.

15. The one or more non-transitory memory devices of claim 14, wherein each historical build package of the plurality of historical build packages corresponds to a historical data log of an installation of the historical build package on deployed computing environment having a first configuration.

16. The one or more non-transitory memory devices of claim 13, wherein the instructions further cause the runtime error prediction computing device to:
forward, via a network and by the runtime error orchestration engine for an unresolved predicted runtime error, components of a build package for analysis via an extended reality engine.

17. The one or more non-transitory memory devices of claim 16, wherein the instructions further cause the runtime error prediction computing device to install the build package in a virtual computing environment.

18. The one or more non-transitory memory devices of claim 13, wherein the instructions further cause the runtime error prediction computing device to:
build, automatically based on an indication of no predicted errors, a build package of a version of the software application;
deploy the build package on one or more deployed computing environments; and
train the AI prediction model based on information of the build package and installation logs retrieved from the deployed computing environments.

19. The method of claim 1, wherein the runtime error comprises a software crash when installed upon a production server.

20. The method of claim 1, further comprising monitoring a build server for an indication of a new version of the software application, wherein the indication comprises one or more of a new production version release indication, a new test version release indication, a revised version release indication and wherein the indication is received from a versioning server during a code push.
